(19) United States
(12) Patent Application Publication
(10) Pub. No.: US 2009/0241994 A1
(43) Pub. Date: Oct. 1, 2009

(54) SOLAR CELL DEVICE

(75) Inventor: HAN-LUNG LEE, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/207,466

(22) Filed: Sep. 9, 2008

(30) Foreign Application Priority Data
Mar. 31, 2008 (CN) 200810300800.X

(51) Int. Cl. B08B 3/04; H01L 31/042; B08B 13/00

(52) U.S. Cl. 134/18; 136/244; 134/58 R

(57) ABSTRACT

A solar cell device includes a solar cell panel having an outer surface and a cleaning system. The cleaning system includes a cleaning component configured for sputtering a cleaning fluid to clean the outer surface, and a controller. The controller is electrically connected to the cleaning component and is configured for controlling the cleaning component.

### CROSS-REFERENCE STATEMENT

The present application is based on, and claims priority from, CN Application Serial Number 200810300800.X, filed on Mar. 31, 2008, titled solar cell device, the disclosure of which is hereby incorporated by reference herein in its entirety.

### BACKGROUND

1. Technical Field

The disclosed embodiments relates to a solar cell device.

2. Description of Related Art

Currently, various solar cell devices have been designed to receive and convert sunlight into electrical energy. Such solar cells have been applied on roofs of buildings and cars, and on various portable electronic devices.

The solar cell devices secured on roofs of building may be subject to contamination such as dirt and dust. The dirt reflects incident sunlight, which affects the sunlight collection of the solar cell devices. Frequently cleaning the solar cell devices is time-consuming and inconvenient.

Therefore, a new solar cell device is desired to overcome the above-described shortcoming.

### SUMMARY

An embodiment of a solar cell device includes a solar cell panel having an outer surface and a cleaning system. The cleaning system includes a cleaning component configured for sputtering a cleaning fluid to clean the outer surface and a controller. The controller is electrically connected to the cleaning component and is configured for controlling the cleaning component.

Other advantages and novel features will become more apparent from the following detailed description when taken in conjunction with the accompanying drawings.

### BRIEF DESCRIPTION OF THE DRAWINGS

Many aspects of the solar cell device can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of one embodiment of a solar cell device.

FIG. 2 is a schematic view of another embodiment of a solar cell device.

FIG. 3 is a flowchart of one embodiment of a method for cleaning a solar cell panel.

### DETAILED DESCRIPTION OF THE EMBODIMENTS

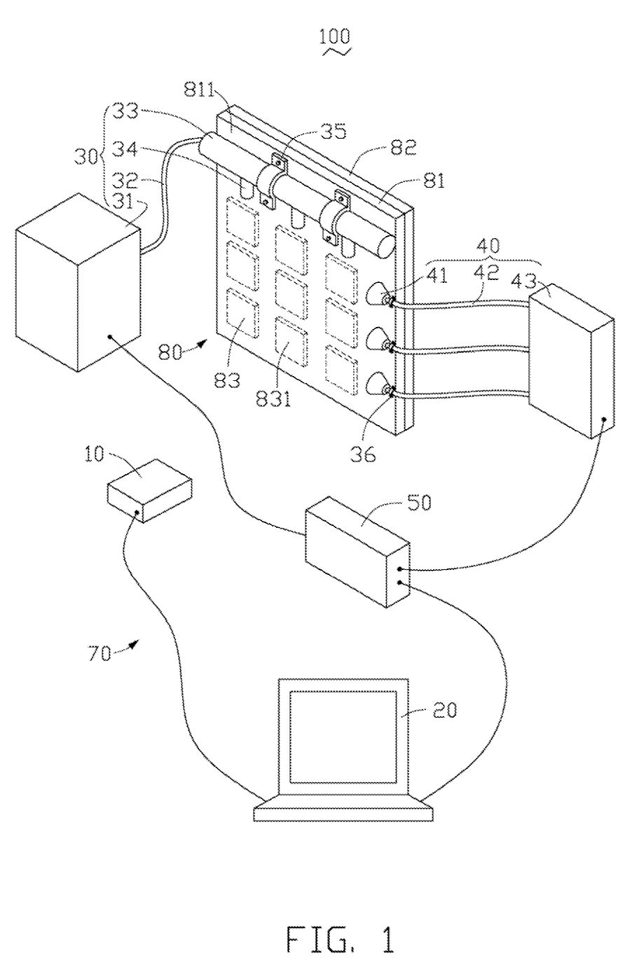

Referring to FIG. 1, one embodiment of a solar cell device 100 includes a solar cell panel 80 and a cleaning system 70.

The solar cell panel 80 includes a cover 81, a substrate 82 and a plurality of solar cell units 83 positioned between the cover 81 and the substrate 82. Each of the plurality of solar cell units 83 has a light reception surface 831 covered by the cover 81. The cover 81 is made of transparent materials and has an outer surface 811.

The cleaning system 70 includes an image pickup component 10, an image processing component 20, a cleaning component 30, a drying component 40 and a controller 50.

The image pickup component 10 is configured for attaining an image data of the outer surface 811. The image pickup component 10 may be a charge coupled device camera or a complementary metal oxide semiconductor camera. The image pickup component 10 is electrically connected to the image processing component 20.

The image processing component 20 is configured for receiving and processing the image data outputted by the image pickup component 10, and sending a cleaning signal to the controller 50. The image processing component 20 may be a computer.

The controller 50 is electrically connected to the image processing component 20 and is configured for turning on or off the cleaning component 30 and the drying component 40 according to the received cleaning signal.

The cleaning component 30 is electrically connected to the controller 50 and is configured for sputtering a cleaning fluid to clean the outer surface 811. The cleaning component 30 includes a fluid driver 31, a fluid-sputtered pipe 33 and a first connection pipe 32 connecting the fluid driver 31 to the fluid-sputtered pipe 33. The fluid driver 31 is configured for driving the cleaning fluid to flow into the first connection pipe 32 and the fluid-sputtered pipe 33. The fluid-sputtered pipe 33 is secured on the outer surface 811 by a plurality of first brackets 35. The fluid-sputtered pipe 33 has a plurality of fluid nozzles 34 configured for sputtering the cleaning fluid to clean the outer surface 811. The cleaning fluid may be water, detergent, or a mixture of water and detergent.

The drying component 40 is electrically connected to the controller 50 and is configured for drying the outer surface 811. The drying component 40 includes an air driver 43, a plurality of air nozzles 41 and a plurality of second connection pipes 42. Each of the plurality of air nozzles 41 is secured to the outer surface 811 by a second bracket 36. Each of the second connection pipes 42 connects each corresponding air nozzle 41 to the air driver 43. The air driver 43 is configured for driving air to dry the outer surface 811.

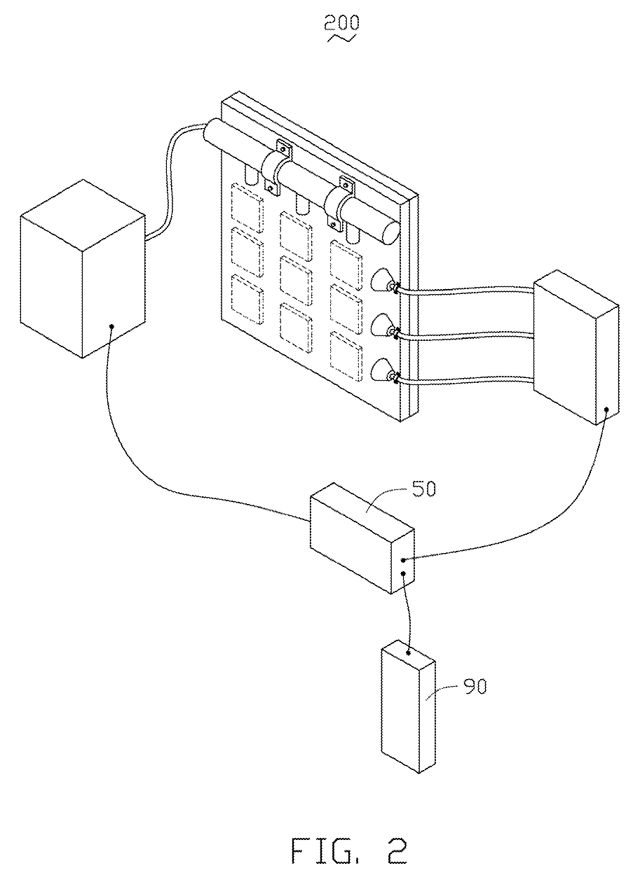

Referring to FIG. 2, another embodiment of a solar cell device 200 is similar to the solar cell device 100 of FIG. 1, except that the image pickup component 10 and the image processing component 20 of FIG. 1 are replaced by a timing device 90. The timing device 90 is electrically connected to the controller 50 and configured to periodically send a cleaning signal to the controller 50. A period of time can be set by a user, for example, five hours.

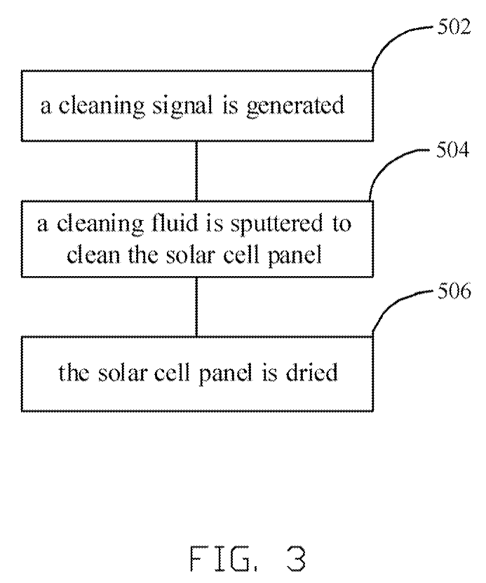

Referring to FIG. 3, is one embodiment of a method for cleaning a solar cell panel. Depending on the embodiment, certain of the steps described below may be removed, others may be added, and the sequence of steps may be altered.

In a step 502, a cleaning signal is generated. In one embodiment, the cleaning signal is generated by the image pickup component 10 and the image processing component 20 of FIG. 1. An initial image data of a clean outer surface of the solar cell panel is stored in the image processing component 20. The image pickup component 10 monitors the outer surface of the solar cell panel to attain a referring image data. The referring image data is sent to the image processing component 20 and is compared with the initial image data by the image processing component 20. The cleaning signal is generated if a difference of cleanliness between the initial image data and the referring image data exceeds a predetermined value. In another embodiment, the cleaning signal may be periodically generated by the timing device 90 of FIG. 2.

Continuing a step 504, a cleaning fluid is sputtered to clean the solar cell panel 80. The cleaning fluid may be sputtered by the cleaning component 30 of FIG. 1. The fluid driver 31 drives the cleaning fluid to flow into the first connection pipe 32 and the fluid-sputtered pipe 33. The fluid-sputtered pipe 33 sputters the cleaning fluid to clean the solar cell panel. The cleaning fluid may be water, detergent, or a mixture of water and detergent.

Moving to a step 506, the solar cell panel 80 is dried. The solar cell panel 80 may be dried by the drying component 40 of FIG. 1. The air driver 43 drives air to flow into the second connection pipe 42. The air is then blown out from the nozzles to dry the solar cell panel.

It is believed that the present embodiments and their advantages will be understood from the foregoing description, and it will be apparent that various changes may be made thereto without departing from the spirit and scope of the invention or sacrificing all of its material advantages, the examples here before described merely being preferred or exemplary embodiments of the invention.

What is claimed is:

1. A solar cell device comprising:
a solar cell panel having an outer surface; and
a cleaning system comprising:
a cleaning component configured for sputtering a cleaning fluid to clean the outer surface; and
a controller electrically connected to the cleaning component and configured for controlling the cleaning component.

2. The solar cell device of claim 1, further comprising an image pickup component configured for attaining an image data of the outer surface, and an image processing component electrically connected to the image pickup component and the controller and configured for processing the image data outputted by the image pickup component and sending a cleaning signal to the controller to turn on the cleaning component.

3. The solar cell device of claim 1, wherein the cleaning component comprises a fluid driver, a fluid-sputtered pipe and a first connection pipe connecting the fluid driver to the fluid-sputtered pipe; the fluid driver is configured for driving the cleaning fluid to flow into the first connection pipe and the fluid-sputtered pipe; the fluid-sputtered pipe is positioned on the outer surface and configured for sputtering the cleaning fluid to clean the outer surface.

4. The solar cell device of claim 3, wherein the fluid-sputtered pipe comprises a plurality of fluid nozzles configured for sputtering the cleaning fluid.

5. The solar cell device of claim 1, wherein the cleaning system further comprises a drying component configured for drying the outer surface; the controller is electrically connected to the drying component and configured for controlling the drying component.

6. The solar cell device of claim 5, wherein the drying component comprises an air driver, a plurality of air nozzles and a plurality of second connection pipes; each of the plurality of air nozzles is positioned on the outer surface; each of the plurality of second connection pipes connects each corresponding air nozzle to the air driver; the air driver is configured for driving air to dry the outer surface.

7. The solar cell device of claim 1, further comprising a timing device electrically connected to the controller and configured for periodically sending a cleaning signal to the controller to turn on the cleaning component.

8. The solar cell device of claim 1, wherein the solar cell panel comprises a cover, a substrate and a plurality of solar cell units positioned between the cover and the substrate; each of the plurality of solar cell units has a light reception surface covered by the cover.

9. A cleaning system comprising:
a cleaning component configured for sputtering a cleaning fluid to clean an outer surface of a solar cell panel; and
a controller electrically connected to the cleaning component and configured for controlling the cleaning component.

10. The cleaning system of claim 9, further comprising an image pickup component configured for attaining an image data of the outer surface, and an image processing component electrically connected to the image pickup component and the controller and configured for processing the image data outputted by the image pickup component and sending a cleaning signal to the controller to turn on the cleaning component.

11. The cleaning system of claim 9, wherein the cleaning component comprises a fluid driver, a fluid-sputtered pipe and a first connection pipe connecting the fluid driver to the fluid-sputtered pipe; the fluid driver is configured for driving the cleaning fluid to flow into the first connection pipe and the fluid-sputtered pipe; the fluid-sputtered pipe is positioned on the outer surface and configured for sputtering the cleaning fluid to clean the outer surface.

12. The cleaning system of claim 11, wherein the fluid-sputtered pipe comprises a plurality of fluid nozzles configured for sputtering the cleaning fluid.

13. The cleaning system of claim 9, wherein the cleaning system further comprises a drying component configured for drying the outer surface; the controller is electrically connected to the drying component and configured for controlling the drying component.

14. The cleaning system of claim 13, wherein the drying component comprises an air driver, a plurality of air nozzles and a plurality of second connection pipes; each of the plurality of air nozzles is positioned on the outer surface; each of the plurality of second connection pipes connects each corresponding air nozzle to the air driver; the air driver is configured for driving air to dry the outer surface.

15. The cleaning system of claim 9, further comprising a timing device electrically connected to the controller and configured for periodically sending a cleaning signal to the controller to turn on the cleaning component.

16. A method for cleaning a solar cell panel, the method comprising:
generating a cleaning signal; and
sputtering a cleaning fluid to clean an outer surface of the solar cell panel.

17. The method of claim 16, wherein the cleaning signal is generated by an image pickup component and an image processing component; the image pickup component attains a referring image data of the outer surface and sends the referring image data to the image processing component; the image processing component compares the referring image data to an initial image data of a clean outer surface; the cleaning signal is generated if a difference of cleanliness between the initial image data and the referring image data exceeds a predetermined value.

18. The method of claim 16, wherein the cleaning signal is periodically generated by a timing device.

19. The method of claim 16, wherein the cleaning fluid to clean the outer surface is sputtered by a cleaning component; the cleaning component comprises a fluid driver, a fluid-sputtered pipe and a first connection pipe connecting the fluid driver to the fluid-sputtered pipe; the fluid driver drives the cleaning fluid to flow into the first connection pipe and the fluid-sputtered pipe; the fluid-sputtered pipe sputters the cleaning fluid to clean the outer surface.

20. The method of claim 16, further comprising drying the outer surface by a drying component; wherein the drying component comprises an air driver, a plurality of air nozzles and a plurality of second connection pipes; each of the plurality of air nozzles is positioned on the outer surface; each of the plurality of second connection pipes connects the corresponding air nozzle to the air driver; the air driver drives air to dry the outer surface.
